(19) United States
(12) Patent Application Publication
(10) Pub. No.: US 2006/0209904 A1
(43) Pub. Date: Sep. 21, 2006

(54) Reverse acknowledgement method for quickly identifying whether or not the retransmission frame was lost

(75) Inventors: Jai Young Lee, Seoul (KR); Je Chan Han, Seoul (KR)

Correspondence Address: QUALCOMM INCORPORATED, 5775 MOREHOUSE DR., SAN DIEGO, CA, 92121, US

(73) Assignee: QUALCOMM Incorporated

(21) Appl. No.: 11/156,025

(22) Filed: Jun. 16, 2005

(30) Foreign Application Priority Data
Mar. 16, 2005 (KR) 10-2005-0021720

(51) Int. Cl. H04J 3/06

(52) U.S. Cl. 370/511

(57) ABSTRACT

The present invention is to provide a novel method for quickly identifying whether or not a retransmission request frame is lost, without waiting for whether a waiting time for tie retransmission request frame has elapsed a retransmission time. The present invention employs a reverse acknowledgement (RA) scheme in order to resolve the problems of a prior art. Herein the reverse acknowledgement represents the notice that a retransmission frame has been already transmitted from a transmission node to a receiving node.

### FIELD OF THE INVENTION

The present invention relates to the reverse acknowledge method for quickly identifying whether or not the retransmission frame was lost.

### BACKGROUND OF THE INVENTION

ARQ (Automatic Retransmit Request) and FEC (Forward Error Correction), or hybrid ARQ using the two have been considered in order to ensure the reliability of a wireless link. An ARQ detects a frame loss at a link layer and implements a retransmission function. Lost frames are detected by an acknowledgement signal (Ack), Negative Ack (NACK), or a polling which are transmitted from a retransmission timer or a receiver. Thereby the ARQ can recover the lost frames to effectively ensure the reliability of a wireless link with respect to an upper transfer protocol.

ARQ transmission schemes can be largely classified into a stop-and-wait ARQ scheme and a sliding window ARQ scheme.

FIG. 1(a) shows a stop-and-wait ARQ scheme. The stop-and-wait ARQ scheme transmits one frame at a time, and then, after confirming that the frame has been successfully transmitted, transmits a next frame. The stop-and-wait ARQ scheme is easy to implement. However, the efficiency is low, since after transmitting one frame, it cannot transmit next frame until it receives an ACK for the transmitted frame. In the sliding window ARQ scheme, a transmitter manages a transmission window to many frames successively, and when a sufficiently large transmission window is used, the sliding window ARQ scheme is very efficient. However, the sliding window ARQ scheme may be relatively complex to implement since it must assign a sequence number for each frame. Exemplary sliding window ARQ schemes are GBN (Go-back-N) ARQ scheme and SR (Selective-Repeat) ARQ scheme.

FIG. 1(b) shows a GBN ARQ scheme, wherein when a transmitter receives an NAK, then it goes back to a block, in which an error occurs, to retransmit all of its subsequent blocks.

FIG. 1(c) shows an SR ARQ scheme, wherein when a receiver receives an NAK, then it finds an error block to retransmit only a corresponding block. Accordingly, the SR ARQ scheme has a good transmission efficiency. However, it requires more complex circuitry and a larger volume of buffer compared with other ARQ schemes, and the receiver needs to rearrange data.

The present invention can be applied to all ARQ systems, but preferably applied to a selective-repeat ARQ system.

In the meantime, FIG. 2 shows a problem of the conventional selective-repeat ARQ scheme.

The transmission node transmits frame nos. 1, 2, 3 and 4 sequentially to the receiving node.

Meanwhile, the receiving node receives the frame nos. 1, 2, 3 and 4 sequentially.

Referring to FIG. 2, frame nos. 1, 3 and 4 are successfully received, but frame no. 2 is received with corruption or loss.

In this case, after identifying that frame no. 3 has been successfully received, the receiving node identifies that frame no. 2 has been lost, and then transmit a retransmission request message (NAK message) to the transmission node and at the same time activates a retransmission timer.

Meanwhile, the transmission node receives the retransmission request message for frame no. 2, retransmits frame no. 2, and subsequently transmits frame nos. 5, 6 and 7.

The retransmission frame no. 2 is lost again, and the receiving node identifies the reception of frame nos. 5, 6 and 7.

In the prior art, even though frame nos. 3, 4, 5, 6 and 7 were well received, since it is not identified whether or not frame no. 2 has been successfully retransmitted until the retransmission time elapsed, frame nos. 3, 4, 5, 6 and 7 cannot be transferred to an upper layer (e.g., TCP), and must wait in the re-sequencing buffer of the receiving node In addition, since the retransmission time of the retransmission timer is set at tens of times a round trip delay, the conventional NAK based ARQ scheme waits for the reception of the lost frame during a long time period in order to identify the loss of the retransmission frame. This leads to a rapid degradation in the processing efficiency for other well-received frames, and there is a drawback that the size of the re-sequencing buffer of the receiving node must be set to be large.

### SUMMARY OF THE INVENTION

Accordingly, in order to resolve the above-described problems of the prior art, the present invention provides a novel method for quickly identifying whether or not the retransmission request frame is lost, without waiting for whether or not the waiting time for the retransmission request frame has elapsed the retransmission time.

The present invention uses a reverse acknowledgement (RA) scheme in order to resolve the problems of the prior art.

Herein the reverse acknowledgement represents the notice that a retransmission frame has been already transmitted from a transmission node to a receiving node.

The RA scheme according to the present invention comprises the steps of:

identifying at a receiving node whether or not a transmitted frame was lost;

transmitting a retransmission request message (NAK message) including an identifier identifying a retransmission frame from the receiving node to the transmission node when the loss of the transmitted frame is identified;

receiving said retransmission request message at the transmission node;

retransmitting the retransmission frame from the transmission node to the receiving node in response to the retransmission request message;

transmitting subsequent frames sequentially at the transmission node, said subsequent frames including the identifier identifying the transmission of the retransmission frame; and

identifying whether or not the retransmission frame was lost based on said identifier included in said subsequent frames when the receiving node receives said subsequent frames.

By using the reverse acknowledgement according to the present invention, an NAK-based ARQ system can quickly identify whether the retransmission frame was lost, and transmits the successfully received frames to the upper layer quickly, thereby increasing the efficiency of the upper layer (e.g., TCP).

### BRIEF DESCRIPTION OF THE DRAWINGS

FIG. 1(a) shows a stop-and-wait ARQ scheme.

FIG. 1(b) shows a GBN ARQ scheme.

FIG. 1(c) shows an SR ARQ scheme.

FIG. 2 shows a problem of a conventional selective-repeat ARQ scheme.

FIG. 3(a) shows the constitution of a retransmission request message according to the present invention.

FIG. 3(b) shows the constitution of a subsequent data frame following the transmission of the retransmission data frame from the transmission node to the receiving node according to the present invention.

FIG. 4(a) shows the flow of data frames in an ARQ system using one reverse acknowledgement according to the present invention.

FIG. 4(b) shows the flow of data frames in an ARQ system using plural reverse acknowledgements according to the present invention.

FIG. 5 is a flow chart showing a reverse acknowledgement scheme according to the present invention.

FIG. 6 shows a reverse acknowledgement table managed at the receiving node.

FIG. 7 is a graph showing the simulation of the relationship between the delay time and the packet error rate in a conventional ARQ system that does not use a reverse acknowledgement and the ARQ system according to the present invention.

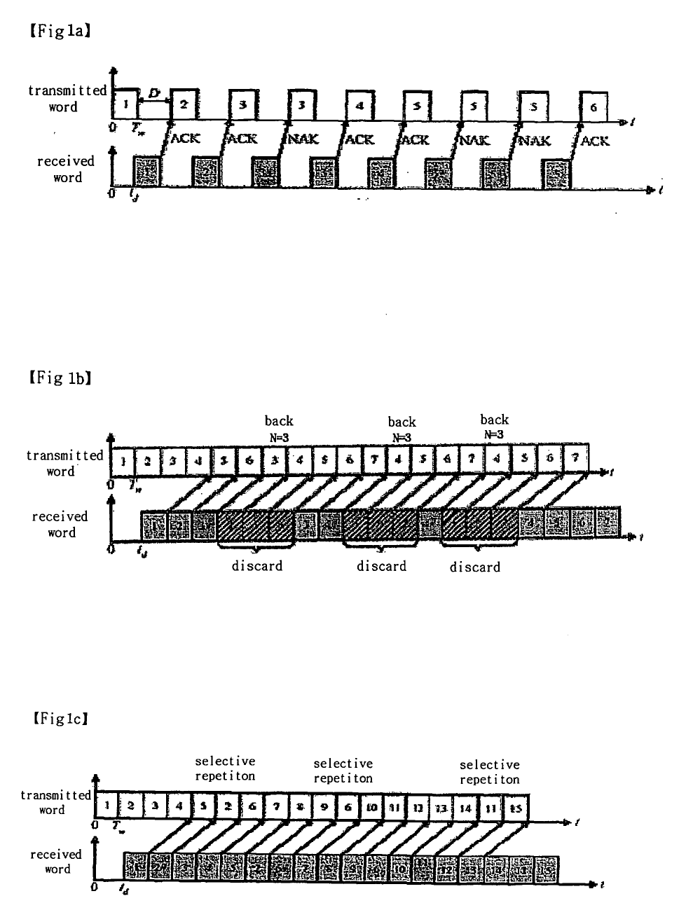

### DETAILED DESCRIPTION OF THE PREFERRED EMBODIMENTS

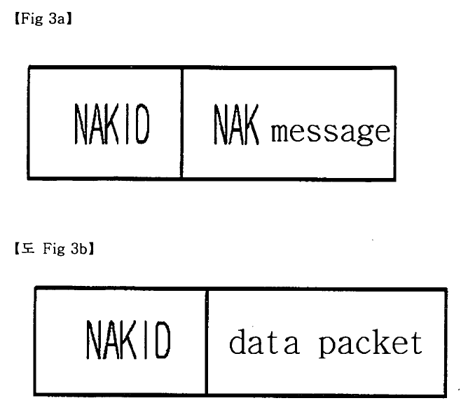

FIG. 3(a) shows the constitution of a retransmission request message according to the present invention.

The retransmission request message according to the present invention comprises a NAK message and a retransmission frame identifier (NAKID). The NAK message is one used in the prior art, and the NAKID is a message used for the reverse acknowledgement according to the present invention. In the meantime, the NAKID transmitted from the receiving node to the transmission node is stored in the reverse acknowledgement (RA) table of the receiving node.

FIG. 3(b) shows the constitution of a subsequent data frame following the transmission of the retransmission data frame from the transmission node to the receiving node according to the present invention.

The subsequent data frames consist of their own frame contents and the NAKID. The contents for the subsequent data frames (consisting of an overhead message and a data payload) are the messages used in the conventional technology, and the NAKID is the message used for the reverse acknowledgement according to the present invention.

As shown in FIGS. 3(a) and 3(b), the present invention transmits the NAKID from the receiving node to the transmission node for the reverse acknowledgement, and the transmission node retransmits a message corresponding to the NAKID to the receiving node, and then notifies that the transmission node have already transmitted the retransmission frame through the NAKID in the subsequent data frames.

Thereby the receiving node can know whether or not the retransmission frame was lost before the retransmission time has elapsed.

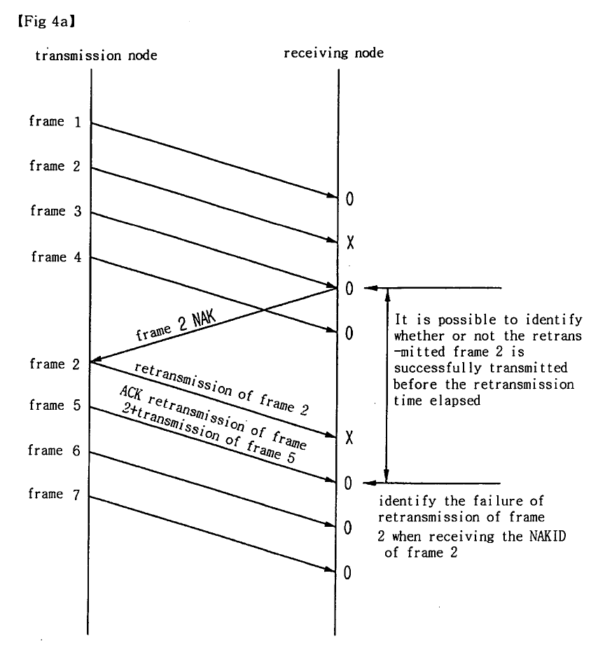

FIG. 4(a) shows the flow of data frames in an ARQ system using one reverse acknowledgement according to the present invention.

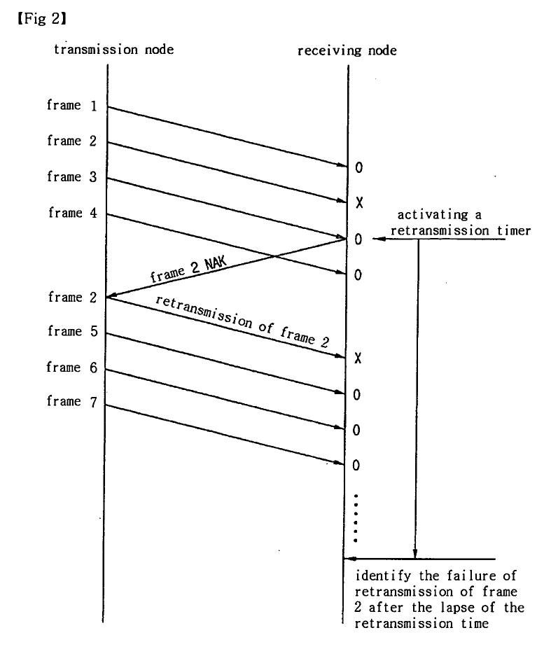

The transmission node, like FIG. 2, transmits frame nos. 1, 2, 3 and 4 sequentially to the receiving node.

Meanwhile, the receiving node receives frame nos. 1, 2, 3 and 4 sequentially.

In FIG. 2, frame nos. 1, 3 and 4 are successfully received, but frame no. 2 is received in corrupted or lost state.

In the event, the receiving node identifies that frame no. 2 has been lost after identifying that frame no. 3 has been successfully received, and then transmits the retransmit request message (NAK message) to the transmission node. Meanwhile, the NAKID is further attached to the retransmit request message as shown in FIG. 3(a).

Meanwhile, the transmission node receives the retransmit request message for frame no. 2, retransmits frame no. 2, and subsequently transmits frame nos. 5, 6 and 7.

Meanwhile, the NAKID is further added to the subsequent frame following the retransmission of frame no. 2, i.e., frame no. 5, as shown in FIG. 3(b). The retransmission frame no. 2 is lost again, and the receiving node identifies the successful reception of frame nos. 5, 6 and 7.

In the meantime, since frame no. 5 includes an identifier (NAKID) informing that frame no. 2 has been already retransmitted from the transmission node, the receiving node recognizes the failure of the retransmission of frame no. 2 before the retransmission time has elapsed.

Accordingly, the receiving node immediately proceeds to the next step without waiting for the lapse of the retransmission time (that is, requesting a further retransmission of frame no. 2 or abandoning the retransmission request of frame no. 2, and transferring the already-received frame nos. 3 and 4 to the upper layer).

As such, the receiving node quickly identifies whether or not the retransmission frame is lost, by using the reverse acknowledgement scheme according to the present invention, and then proceeds to the next step, thereby resolving the above-described problem of the prior art.

Meanwhile, referring to FIG. 4(a), the retransmission frame no. 2 may be received after frame no. 5 has been received. When the retransmission frame no. 2 is not a direct signal but a signal that is reflected by other things in the signal path, it may occur that the late transmitted frame no. 5 is first received, and then the retransmission frame no. 2 is received.

When the retransmission frame no. 2 arrives after frame no. 5 (the subsequent frame), an error occurs.

Accordingly, in order to prevent such error, the NAKID is added to frame nos. 6 and 7 as well as to frame no. 5, so the receiving node may use a method, which identifies whether or not the retransmission frame no. 2 is lost after all the three NAKIDs have been received.

Of course, even if the NAKID is used for the three frames as described above, if the retransmission frame no. 2 is received before the reception of frame no. 5, the successful transmission of the retransmission frame can be identified without the need of waiting for the reception of an additional NAKID. However, the loss of the retransmission frame cannot be identified until the three NAKIDs are received.

Meanwhile, FIG. 4(b) shows the above-described process of identifying the loss of the retransmission frame no. 2 after plural NAKIDs (three NAKIDs in the above embodiment) have been received.

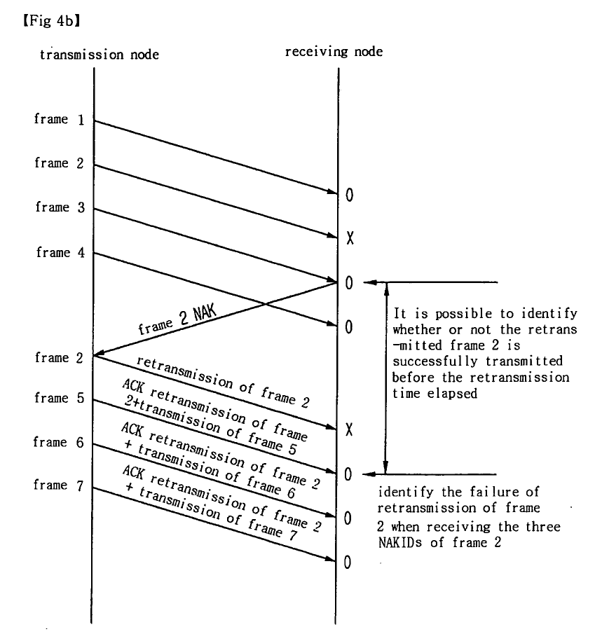

FIG. 5 is a flow chart showing a reverse acknowledgement scheme according to the present invention.

The process starts in step 500.

In step 510, the receiving node identifies that the transmission frame was lost. The receiving node identifies the loss of frame no. 2, for example, when the receiving node receives frame no. 1 and subsequently receives frame no. 3, not frame no. 2.

In step 520, the receiving node transmits a message requesting for the retransmission of the lost frame. Herein, the retransmission request message includes the NAKID identifying the retransmission frame for the reverse acknowledgement.

In step 530, the transmission node receives the retransmission request message, and then retransmits the retransmission request frame to the receiving node.

In step 540, the transmission node transmits the subsequent frame to the receiving node, and at the same time adds the NAKID to the subsequent frame to acknowledge the transmission of the retransmission frame to the receiving node (reverse ack).

In step 550, the receiving node receives the subsequent frame, and identifies through the NAKID included in the subsequent frame that the retransmission frame has been already transmitted, and identifies that the retransmission frame has been lost if the retransmission frame has not yet been received.

Then, the above-described process terminates in step 560.

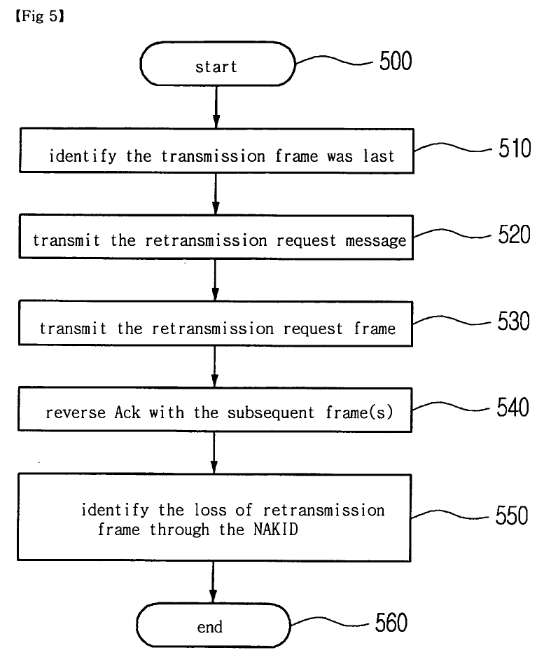

FIG. 6 shows a reverse acknowledgement table, which is managed at the receiving node.

The reverse acknowledgement table comprises a NAKID, a lost packet list, and a state indicator.

The reverse acknowledgement table is updated when the loss of the transmission frame is identified and when the success or failure of the retransmission frame is identified.

For example, when the loss of frame nos. 2 and 5 is identified, NAKIDs 1 and 2 are assigned to frame nos. 2 and 5, respectively, and when the successful retransmission of frame no. 2 is identified, the contents of frame no. 2 is removed from the table.

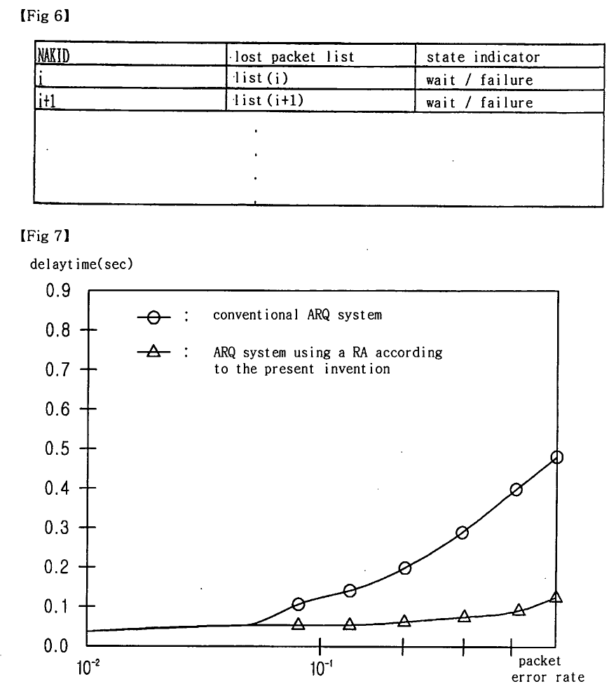

FIG. 7 is a graph showing the simulation of the relationship between the delay time and the packet error rate in a conventional ARQ system that does not use a reverse acknowledgement and in the ARQ system according to the present invention. Herein, the retransmission persistence was set as 1.

As shown in the drawings, the delay time rapidly increases in the ARQ system according to the conventional art as the pack error rate increases, whereas the delay time increases gradually in the ARQ system according to the present invention as the pack error rate increases.

Thus, the present invention is very effective in an ARQ system having a large packet error rate.

The steps of flow diagrams and the functionality described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

We claim:

1. A reverse acknowledgement method for quickly identifying whether a retransmission frame was lost in an NAK-based ARQ system, comprising the steps of:
identifying at a receiving node whether or not a transmitted frame was lost;
transmitting a retransmission request message (NAK message)including an identifier identifying a retransmission frame from the receiving node to the transmission node when the loss of the transmitted frame is identified;
receiving said retransmission request message at the transmission node;
retransmitting the retransmission frame from the transmission node to the receiving node in response to the retransmission request message;
transmitting subsequent frames sequentially at the transmission node, said subsequent frames including the identifier identifying the transmission of the retransmission frame; and
identifying whether or not the retransmission frame was lost based on said identifier included in said subsequent frames when the receiving node receives said subsequent frames.

2. The reverse acknowledgement method according to claim 1, wherein an identifier identifying said retransmission and identifier identifying the transmission of retransmission frame are an NAKID.

3. The reverse acknowledgement method according to claim 1 or 2, wherein said ARQ system is a selective repeat ARQ system.

4. The reverse acknowledgement method according to claim 1 or 2, wherein the identifier identifying the transmission of the retransmission frame is added only to a subsequent frame just following the retransmission frame.

5. The reverse acknowledgement method according to claim 1 or 2, wherein the identifier identifying the transmission of the retransmission frame is added to plural subsequent frames of the retransmission frame to be transmitted.

6. The reverse acknowledgement according to claim 5, wherein said plural subsequent frames are three subsequent frames, and said step of identifying whether or not the retransmission frame was lost is implemented after the three subsequent frames are received at the receiving node.

7. The reverse acknowledgement method according to claim 1 or 2, wherein said step of identifying whether or not the retransmission frame was lost, and identifies that the retransmission frame was not lost when the retransmission frame corresponding to the identifier identifying the transmission of the retransmission frame has been already received, and identifies that the retransmission frame was lost when the frame corresponding to the identifier identifying the transmission of the retransmission frame has not yet been received.

8. The reverse acknowledgement method according to claim 1 or 2, wherein said method further comprises the step of transferring the received frames to an upper layer when the loss of the retransmission frame is identified, without transmitting a retransmit request message any more.

9. A method for managing a reverse acknowledgement table for identifying whether or not a retransmission frame was lost in an NAK-based ARQ system, comprising the steps of:
configuring the reverse acknowledgement table comprising an NAK identifier (NAKID), a lost packet list, and a retransmission state indicator of lost packets; and
updating the reverse acknowledgement table depending on the success or failure or retransmission packet.

10. The method for managing a reverse acknowledgement table according to claim 9, wherein said step of updating the reverse acknowledgement table comprises the steps of:
assigning an NAKID to the lost packet when the transmitted packet was lost by adding the lost packet to the reverse acknowledgement table, and
removing the NAKID corresponding to the identified retransmitted packet from the reverse acknowledgement table when the retransmitted packet was successfully received or lost.

11. The method for managing a reverse acknowledgement table according to claim 9 or 10, wherein said ARQ system is a selective repeat ARQ system.
